(19) United States
(12) Patent Application Publication
(10) Pub. No.: US 2025/0037352 A1
(43) Pub. Date: Jan. 30, 2025

(54) VOLUMETRIC VIDEO GUIDE

(71) Applicant: International Business Machines Corporation, Armonk, NY (US)

(72) Inventors: Charan Acharya Chandrashekar, Bangalore (IN); Pydimarri Venkata Anantha Sai Avinash, Podili (IN); Shridhara Hegde, Bengaluru (IN)

(21) Appl. No.: 18/227,559

(22) Filed: Jul. 28, 2023

(51) Int. Cl. G06T 15/20; G06T 7/73; G06T 15/08; G06T 17/00

(52) U.S. Cl. CPC G06T 15/20; G06T 7/73; G06T 15/08; G06T 17/005; G06T 2207/10016; G06T 2207/20081

(57) ABSTRACT

Providing a guide to volumetric video viewing includes receiving a request for a video from a viewer. At least one object of viewer's interest is determined. The video and object metadata associated with objects rendered in the video are received. Based on the object metadata, a position of at least one object of viewer's interest in the received video is identified. Viewer's view is guided toward the identified position in the video where the object of viewer's interest is found, as the video plays on a device of the viewer.

### BACKGROUND

The present application relates generally to computers and computer applications, and more particularly to a volumetric video viewer guide.

### BRIEF SUMMARY

The summary of the disclosure is given to aid understanding of a computer system and method of guiding volumetric video viewer, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In some embodiments, a computer-implemented method includes receiving a request for a video from a viewer. The method also includes determining at least one object of viewer's interest. The method further includes receiving the video and object metadata associated with objects rendered in the video. The method also includes, based on the object metadata, identifying a position of the at least one object of viewer's interest in the received video. The method also includes guiding the viewer's view to the position as the video plays on a device of the viewer.

A system in some embodiments includes at least one computer processor. The system also includes at least one memory device coupled with the at least one computer processor. At least one computer processor is configured to receive a request for a video from a viewer. At least one computer processor is also configured to determine at least one object of viewer's interest. At least one computer processor is also configured to receive the video and object metadata associated with objects rendered in the video. At least one computer processor is also configured to, based on the object metadata, identify a position of the at least one object of viewer's interest in the received video. At least one computer processor is also configured to guide the viewer's view to the position as the video plays on a device of the viewer.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement a volumetric video viewer guide in an embodiment.

FIG. 2 shows an example scenario of a user viewing a volumetric video in some embodiments.

FIG. 3 shows an example of volumetric video capturing in some embodiments.

FIG. 4 shows a viewer viewing the captured volumetric video in some embodiments.

FIG. 5 is a diagram illustrating a method of guiding a volumetric video view in some embodiments.

FIG. 6 is a flow diagram illustrating a method of rendering a 3D volumetric video in some embodiments.

FIG. 7 is a diagram showing components of a system that guides volumetric video viewing in some embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as volumetric video viewer guide algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

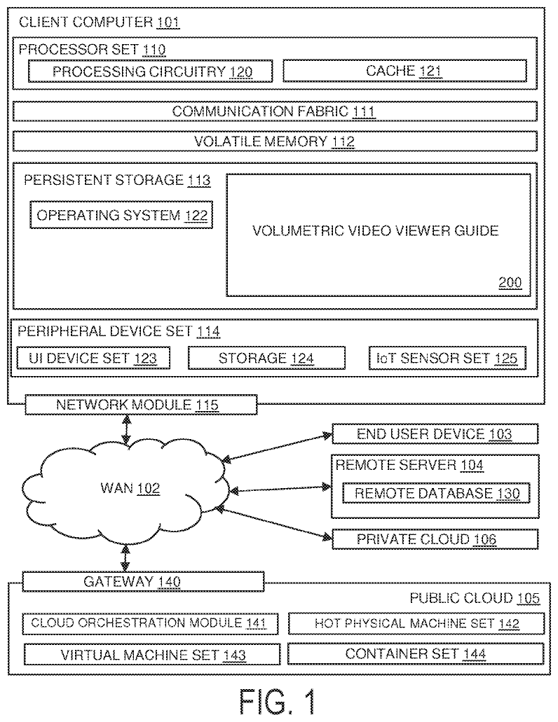

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Systems, methods and techniques are disclosed, in some embodiments, which are related to volumetric video, and also related to providing viewer experience of volumetric video. For example, a system and method can guide a volumetric video viewer to watch a subject of the viewer's interest. Volumetric video is used for capturing a three-dimensional space such as a place, person, or any object. Volumetrically captured objects, environments, and living entities can be transferred to the web (World Wide Web), mobile or virtual worlds for natural three dimensional (3D) viewing. Users can watch volumetric video through virtual reality (VR), a mobile device such as a smartphone, computer, and/or other devices, allowing viewers to interact with the scene or object in 3D space. Volumetric video can be live. Volumetric video can also be a replay of an existing video. For example, volumetric video can be a live telecast or replay of old video.

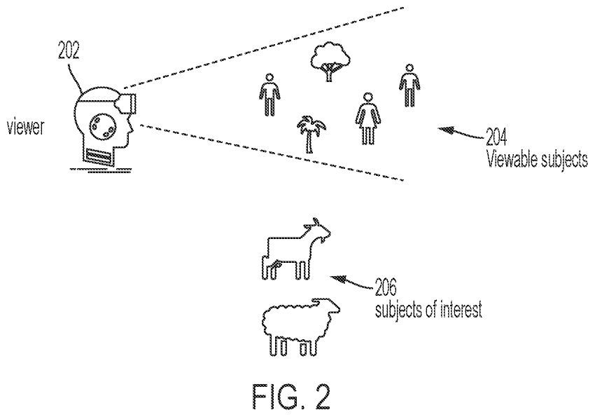

FIG. 2 shows an example scenario of a user viewing a volumetric video in some embodiments. Consider a scenario where a user (also referred to as a viewer) 202 is watching a wildlife sanctuary video 204 and the user is specifically interested in viewing certain subjects 206. Since the volumetric video provides a 360-degree viewing angle for every scene, it is not easy for user to find the subjects in the video. If the user is looking at a wrong angle, then user may very well miss seeing the subjects of interest. In an existing video, the user may need to replay the video multiple times to search for and find the object of interest, e.g., in this example, certain subjects. In a live streaming video, where no prior video recording exists, the user may not be able to see the tiger in the scene. Such problems may exist in all volumetric videos that provide 360-degree immersive viewing experience containing user's specific object of interest.

In some embodiments, a system and/or method can be provided that can guide a volumetric video viewer in viewing the video, for example, by identifying a plurality of objects of viewer's interest, tagging 3D objects during a processing phase, e.g., with metadata, rendering the tagged metadata to a viewer device, and allowing the viewer device to guide the viewer based on tagged metadata. In some embodiments, the plurality of objects of viewer's interest can be identified by learning a viewer's viewing history, e.g., using a machine learning model. In some embodiments, the users can be given an option to explicitly specify the interest. For example, one of or both of learned viewer's viewing history using a machine learning model and user specified interest can be used. In some embodiments, the 3D objects can be tagged using an image processing and/or video processing technology, and can be associated with a voxel or set of voxels in volumetric space, and updated in an Octree data structure. The tagged metadata can be rendered to a viewer's device while streaming the volumetric video. In some embodiments, a volumetric video viewer's device processes the 3D object tagged with metadata, identifies positions or locations of the interested objects in the volumetric and/or virtual space, and guides the viewer towards the objects of interest. In some embodiments, if the volumetric video is a replay, then the 3D object tagged with metadata can be pre-sent (sent beforehand) to notify the user about the position of the object of interest in future time so that user can adjust the user's position in the real world to prepare the user to watch the object of interest.

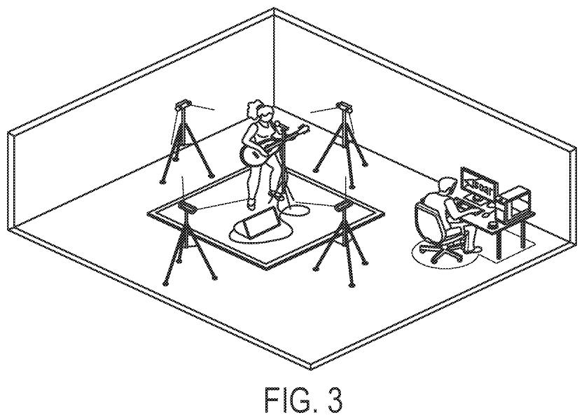

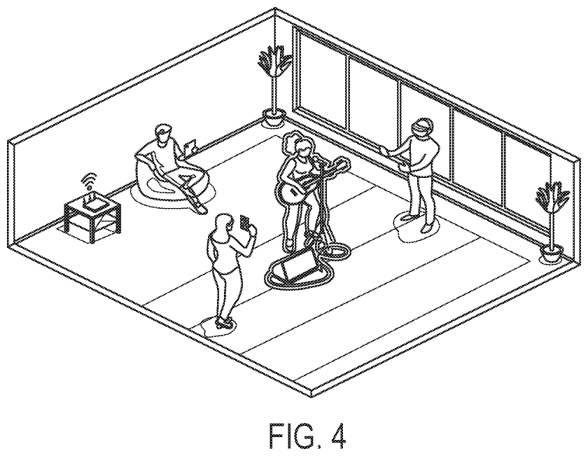

Volumetric video is a type of video technology that captures a subject or scene in 3D space, allowing the viewer to move around and explore the video from different angles. FIG. 3 shows an example of volumetric video capturing in some embodiments. Multiple cameras can be placed in a real space to capture a volumetric video. FIG. 4 shows a viewer viewing the captured volumetric video in some embodiments.

Since volumetric video provides immersive experience with multiple angles to view a scene, there is a high possibility that viewer might miss seeing the object or plurality of objects of his interest. A system and/or method in some embodiments guide a viewer to view and move towards the objects of viewer's interest.

In some embodiments, objects of viewer's interest can be identified from past viewing history using a machine learning model. Examples of machine learning models that can be used to identify one or more objects of viewer's interest include, but are not limited to random forest and deep learning. Random forest is a decision tree-based algorithm that can be used to determine users' interest by collecting data about the user and their interactions with content. Information or data collection pertaining to a user is done with the permission of the user, e.g., on an opt-in or opt-out basis, where the user is given an option to permit data collection or decline/refuse to permit such data collection. Deep learning is another machine learning model based on neural network that can be used to determine user's interest.

In some embodiments, a processor may tag objects in video frames. For instance, objects in the video frames can be recognized during processing phase of volumetric video. For example, there are multiple stages in processing phase of volumetric video such as acquisition, registration, reconstruction, and others, where object recognition can be performed. Known or available technique can be used for object recognition in video images or frames.

3D model reconstruction is a stage in processing phase of volumetric video, during which objects can be recognized. For instance, in some embodiments, object recognition can be performed during the 3D model reconstruction state in volumetric video processing. In other embodiments, object recognition can be performed during another stage of volumetric video processing, e.g., based on an implementation strategy. In some embodiment, known or available algorithms such as machine learning or another artificial intelligence algorithms can be used to recognize objects in the video images or frames. In some embodiments, once the objects are recognized, metadata related to the objects can be stored in Octree data structure. Octree data structure is used for efficiently storing and rendering volumetric video or 3D data.

The video can be rendered along with the object tagging metadata. For instance, a volumetric video server can render the video. Devices used by a viewer to view a volumetric video generally decodes the video data that is sent by the server. For instance, a 3D volumetric representation of a scene can be encoded as a plurality of voxels, for example, stored in octree data structure, which contains multiple levels. User or viewer devices can decode such representation for rendering or presenting the video on the viewer device. For instance, viewer or user devices such as VR headsets, augmented reality (AR) devices, computers, mobile devices, and/or other devices, can be used for watching volumetric videos.

During decoding phase of volumetric video by viewer's device, the device can map the objects of viewer's interest with the objects present in the scene and identify the positions of objects in the scene. Once the objects are identified, guidance is provided to viewer to view the object. In some embodiments, the viewing perspective on the video can automatically move towards the objects. In some embodiments, guidance can be provided in the form of arrows, text, or other indications displayed or presented on the video viewing window of the device.

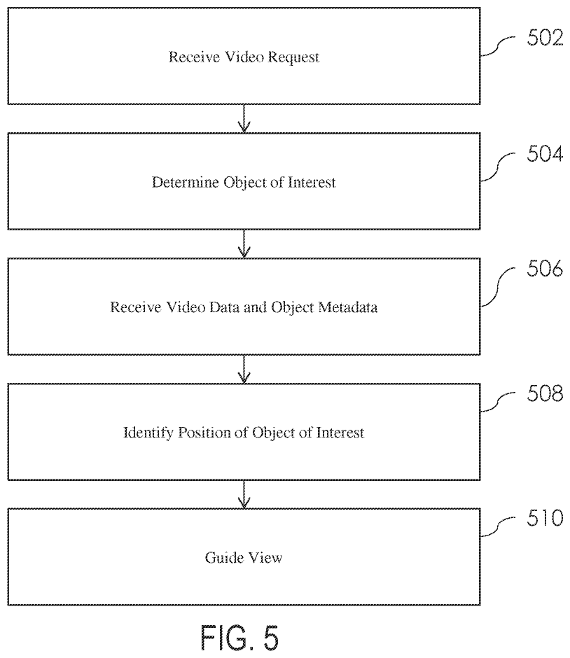

FIG. 5 is a flow diagram illustrating a method of guiding a volumetric video viewer in some embodiments. The method can be performed or implemented by one or more computer processors, e.g., including one or more hardware processors, e.g., in a computing environment described above with reference to FIG. 1. At 502, the method includes receiving a request for a video from a viewer. For example, a user or a viewer may make such requests via a user device or view device such as a computer, laptop, VR/AR headset, smartphone, and/or others.

At 504, the method includes determining at least one object of viewer's interest. In some embodiments, one or more objects of viewer's interest can be specified by a user, e.g., received from a user. In some embodiments, one or more of objects of viewer's interest can be learned automatically using a trained machine learning model to predict at least one object of viewer's interest. For example, machine learning models such as neural networks or other machine learning models can be trained using a training data set that includes feature vectors representing prior or past user viewing patterns or behavior in viewing videos. Known and available techniques and/or tools can be used to train a machine learning model to classify or predict one or more objects of viewer's interests.

At 506, the method includes receiving the video (e.g., rendered 3D video/image content) and object metadata associated with objects rendered in the video. For example, in some embodiments, a 3D video stream or data with object metadata associated with objects in the video can be received, e.g., over a computer network, from a server that processed a captured video. In some embodiments, the viewing device may have a 3D video stored locally and the receiving of the video can include retrieving the 3D video stream from a local storage associated with the viewing device.

In some embodiments, the object metadata associated with objects rendered in the video is generated during a stage in volumetric video processing of the video, and stored as octree data structure. The object metadata associated with objects rendered in the video includes indices of voxels in three-dimensional rendering of the video, e.g., voxel indices where the objects of interest are located in the 3D rendering of the volumetric video. Voxels refer to volume elements of 3D space in computer graphics.

At 508, the method includes, based on the object metadata, identifying a position of at least one object of viewer's interest in the received video. For example, voxel indices of voxels that include rendering of at least one object of viewer's interest in the video can be identified by matching objects by their labels.

At 510, the method includes guiding the viewer's view to the position as the video plays on a device of the viewer. In some embodiments, guiding of the viewer's view includes providing a directional indicator that directs the viewer to move the viewer's view in the direction of the identified position. For example, an arrow symbol in the direction of one or more objects of viewer's interest can be shown with the video presentation. As another example, text can be provided that describes where in the video the object of interest is located. In some embodiments, guiding of the viewer's view includes automatically moving a view of the video and focusing in an area of the identified position in the video as the video is playing. For instance, as the video is playing the area around the identified position, and thus, the object of viewer's interest, can be shown.

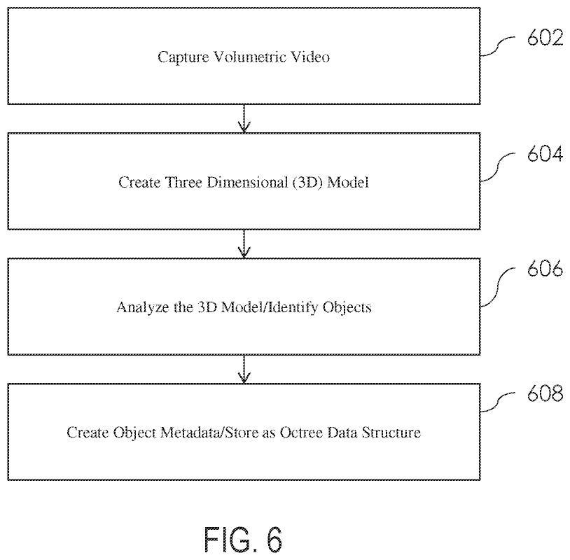

FIG. 6 is a flow diagram illustrating a method of rendering a 3D volumetric video in some embodiments. The method can be performed or implemented by one or more computer processors, e.g., including one or more hardware processors, e.g., in a computing environment described above with reference to FIG. 1. At 602, volumetric video is captured. For example, a camera and recording device can be used to capture real life scenes in 3D real space, in some embodiments. At 604, one or more 3D models are created that represent the capture volumetric video. Known and available video processing techniques and/or tools can be used. At 606, the 3D models are analyzed and objects represented in the 3D models are identified. Known and available techniques can be used to classify or identify object images in volumetric videos. At 608, object metadata associated with identified objects are created and stored as data structure. In some embodiments, the object metadata are stored as octree data structure. An octree is a tree data structure. In octree, each internal node has eight children. Octrees are used to partition a three-dimensional space by recursively subdividing the three-dimensional space into eight octants. Other data structures can also be used for storing the object metadata.

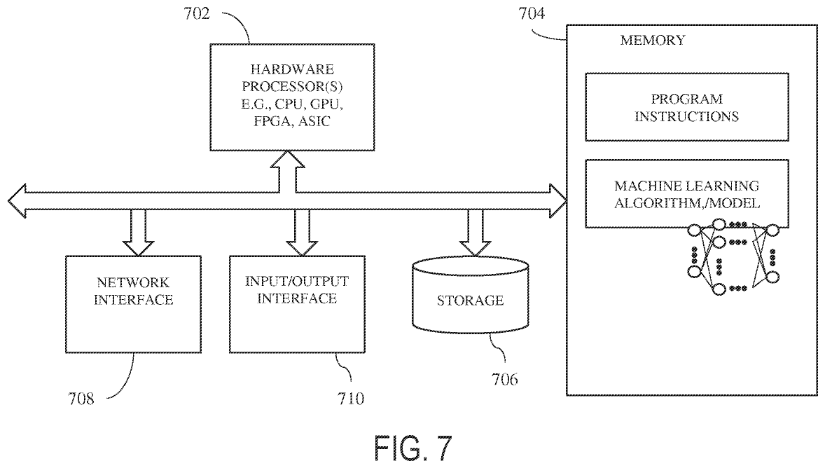

FIG. 7 is a diagram showing components of a system that guides volumetric video viewing in some embodiments. One or more hardware processors 702 such as a central processing unit (CPU), a graphic process unit (GPU), and/or a Field Programmable Gate Array (FPGA), an application specific integrated circuit (ASIC), and/or another processor, may be coupled with a memory device 704, and provide volumetric video viewing guidance. A memory device 704 may include random access memory (RAM), read-only memory (ROM) or another memory device, and may store data and/or processor instructions for implementing various functionalities associated with the methods and/or systems described herein. One or more processors 702 may execute computer instructions stored in memory 704 or received from another computer device or medium. A memory device 704 may, for example, store instructions and/or data for functioning of one or more hardware processors 702, and may include an operating system and other program of instructions and/or data. One or more hardware processors 702 may receive a request for a video from a viewer. One or more hardware processors 702 may determine at least one object of viewer's interest, e.g., using machine learning. One or more hardware processors 702 may receive the video and object metadata associated with objects rendered in the video. One or more hardware processors 702 may, based on the object metadata, identify a position of at least one object of viewer's interest in the received video. One or more hardware processors 702 may guide the viewer's view to the position as the video plays on a device of the viewer. In one aspect, data such as 3D volumetric video data may be stored in a storage device 706 or received via a network interface 708 from a remote device, and may be temporarily loaded into a memory device 704 for providing guidance for viewing the video. One or more hardware processors 702 may be coupled with interface devices such as a network interface 708 for communicating with remote systems, for example, via a network, and an input/output interface 710 for communicating with input and/or output devices such as a keyboard, mouse, display, and/or others.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving a request for a video from a viewer;
determining at least one object of viewer's interest;
receiving the video and object metadata associated with objects rendered in the video;
based on the object metadata, identifying a position of the at least one object of viewer's interest in the received video; and
guiding the viewer's view to the position as the video plays on a device of the viewer.

2. The computer-implemented method of claim 1, wherein the determining of the at least one object of viewer's interest includes receiving the at least one object of viewer's interest specified by the viewer.

3. The computer-implemented method of claim 1, wherein the determining of the at least one object of viewer's interest includes using a trained machine learning model to predict the at least one object of viewer's interest.

4. The computer-implemented method of claim 1, wherein the guiding of the viewer's view includes providing a directional indicator that directs the viewer to move the viewer's view in a direction of the identified position.

5. The computer-implemented method of claim 1, wherein the guiding of the viewer's view includes automatically moving a view of the video and focusing in an area of the identified position in the video as the video is playing.

6. The computer-implemented method of claim 1, wherein the object metadata associated with objects rendered in the video is generated during a stage in volumetric video processing of the video, and stored as octree data structure.

7. The computer-implemented method of claim 1, wherein the object metadata associated with objects rendered in the video includes indices of voxels in three-dimensional rendering of the video.

8. A computer program product comprising a computer readable storage medium having program instructions embodied therewith, the program instructions readable by a device to cause the device to:
receive a request for a video from a viewer;
determine at least one object of viewer's interest;
receive the video and object metadata associated with objects rendered in the video;
based on the object metadata, identify a position of the at least one object of viewer's interest in the received video; and
guide the viewer's view to the position as the video plays on a device of the viewer.

9. The computer program product of claim 8, wherein the at least one object of viewer's interest is specified by the viewer.

10. The computer program product of claim 8, wherein the at least one object of viewer's interest is learned using a trained machine learning model trained to predict the at least one object of interest.

11. The computer program product of claim 8, wherein to guide the viewer's view, the device is caused to provide a directional indicator that directs the viewer to move the viewer's view in a direction of the identified position.

12. The computer program product of claim 8, wherein to guide the viewer's view, the device is caused to automatically move a view of the video and focus in an area of the identified position in the video as the video is playing.

13. The computer program product of claim 8, wherein the object metadata associated with objects rendered in the video is generated during a stage in volumetric video processing of the video, and stored as octree data structure.

14. The computer program product of claim 8, wherein the object metadata associated with objects rendered in the video includes indices of voxels in three-dimensional rendering of the video.

15. A system comprising:
at least one computer processor;
at least one memory device coupled with the at least one computer processor;
the at least one computer processor configured to at least:
receive a request for a video from a viewer;
determine at least one object of viewer's interest;
receive the video and object metadata associated with objects rendered in the video;
based on the object metadata, identify a position of the at least one object of viewer's interest in the received video; and
guide the viewer's view to the position as the video plays on a device of the viewer.

16. The system of claim 15, wherein the at least one object of viewer's interest is specified by the viewer.

17. The system of claim 15, wherein the at least one object of viewer's interest is learned using a trained machine learning model trained to predict the at least one object of interest.

18. The system of claim 15, wherein to guide the viewer's view, the computer processor is configured to provide a directional indicator that directs the viewer to move the viewer's view in a direction of the identified position.

19. The system of claim 15, wherein to guide the viewer's view, the computer processor is configured to automatically move a view of the video and focus in an area of the identified position in the video as the video is playing.

20. The system of claim 15, wherein the object metadata associated with objects rendered in the video is generated during a stage in volumetric video processing of the video, and stored as octree data structure.
